(19) United States
(12) Patent Application Publication
(10) Pub. No.: US 2026/0134404 A1
(43) Pub. Date: May 14, 2026

(54) GUIDED WORKFLOWS AND PREREQUISITE EXTRACTION FOR PERFORMING MAINTENANCE ON AUTOMATION DEVICES

(71) Applicant: Rockwell Automation Technologies, Inc., Mayfield Heights, OH (US)

(72) Inventors: Patryk Woszczyna, Krakow (PL); Lukasz Gornikowski, Kraków (PL); Kurt D. Sneen, Park City, UT (US); Jonathan A. Mills, Mayfield Heights, OH (US)

(21) Appl. No.: 18/948,010

(22) Filed: Nov. 14, 2024

(51) Int. Cl. G06Q 10/20; G06F 3/0482

(52) U.S. Cl. CPC G06Q 10/20; G06F 3/0482

(57) ABSTRACT

The disclosure describes an application service that provides guided workflows for performing maintenance on industrial automation devices. In response to a request from a user, the application service retrieves documentation associated with the device and generates an assistance prompt requesting a list of prerequisites and a list of steps for performing the maintenance. The application service leverages a generative artificial intelligence model by submitting the prompt to obtain an ordered list of steps for performing the maintenance along with the prerequisites, and in some cases safety precautions. The application service transmits the list of prerequisites to a user device for display, which the user may use to prepare for performing the maintenance.

### CROSS-REFERENCE TO RELATED APPLICATIONS

This U.S. Patent Application is related to co-pending U.S. Patent Application titled “INDUSTRIAL AUTOMATION GENERATIVE ARTIFICIAL INTELLIGENCE ASSISTANCE INTERFACE WITH INTEGRATED ORGANIZATION CAPABILITIES,” Attorney Docket Number 2024P-224-US, filed concurrently, the contents of which are incorporated herein in their entirety for all purposes.

This U.S. Patent Application is related to co-pending U.S. Patent Application titled “INDUSTRIAL ASSISTANCE PROMPT GENERATION WITH QR CODE DRIVEN DATA RETRIEVAL,” Attorney Docket Number 2024P-225-US, filed concurrently, the contents of which are incorporated herein in their entirety for all purposes.

This U.S. Patent Application is related to co-pending U.S. Patent Application titled “SYNTHESIZING DOMAIN-BASED RESPONSES IN INDUSTRIAL AUTOMATION SYSTEMS LEVERAGING GENERATIVE ARTIFICIAL INTELLIGENCE,” Attorney Docket Number 2024P-227-US, filed concurrently, the contents of which are incorporated herein in their entirety for all purposes.

### BACKGROUND

Technicians in industrial automation environments regularly perform maintenance (e.g., regular maintenance, troubleshooting, and the like) for industrial automation devices. Maintenance is often a complex process since there are many types of tasks, and each task may have specific procedures and prerequisites. For example, the tasks may require specific tools, safety equipment, and software applications to be completed properly. Before beginning the troubleshooting process or regular maintenance, a technician often gathers the appropriate tools and equipment required to address the particular situation. Inefficiencies may arise when a technician begins without first checking all prerequisites. For instance, the device may experience increased downtime if a technician powers off the device and opens it without having required tools to complete the maintenance.

Device documentation provides guidance to technicians for performing the appropriate maintenance steps. However, prerequisites for performing maintenance may be scattered across multiple documents or in different locations within a document. This fragmentation creates inefficiencies, as technicians may need to spend additional time searching for the necessary information before they can begin performing the maintenance. In some cases, a technician might identify the correct steps to perform the maintenance but miss important details about the prerequisites. Accordingly, improvements are needed to help ensure maintenance can be performed more efficiently in industrial automation environments.

### SUMMARY

The disclosure describes an application service that leverages a general artificial intelligence (GAI) model to provide guided maintenance and troubleshooting for industrial automation devices. In response to a request from a user, the application service submits a prompt to the GAI model requesting a list of prerequisites for performing the maintenance and a list of steps for performing the maintenance. The prompt submitted to the GAI model includes documentation associated with the industrial automation device as contextual information for generating the prerequisites and steps. The application service transmits the prerequisites and steps to a user device for display in a graphical user interface. A guided workflow is thus provided to the user on the user device, including a list of prerequisites for performing the maintenance, alleviating the above-described issues.

One example of a computer-implemented method performed according to some implementations includes receiving, by an application service, a request for a guided workflow for performing maintenance on an industrial automation device. The method further includes retrieving documentation associated with the industrial automation device. The method further includes generating an assistance prompt designed to elicit a response from a general artificial intelligence (GAI) model. The assistance prompt tasks the GAI model with generating a list of prerequisites associated with performing the maintenance and a list of steps for performing the maintenance. The assistance prompt includes the documentation and an identification of the maintenance. The method further includes transmitting, by the application service, the list of prerequisites to a user device for display via a graphical user interface (GUI).

In some implementations, the assistance prompt further tasks the GAI model with generating a list of safety precautions to follow while performing the maintenance. The method further includes transmitting, by the application service, the list of safety precautions to the user device for display via the GUI.

In some implementations, the troubleshooting prompt further includes customer-specific safety documentation. The list of safety precautions includes customer-specific precautions extracted from the customer-specific safety documentation and general precautions extracted from the documentation.

In some implementations, the method further includes transmitting, by the application service, instructions to the user device to display the list of steps in checklist format.

In some implementations, the method further includes receiving, via the GUI, a user selection of a step from the list of steps to indicate completion of the step. The method further includes transmitting instructions to mark the step as complete in the GUI.

In some implementations, the method further includes generating, by the application service, a maintenance report in response to each step in the list of steps being marked complete. The method further includes providing, by the application service, the maintenance report to the user device.

The method further includes selecting a domain associated with the industrial automation device in response to the request for a guided workflow. The documentation is retrieved from the selected domain.

In some implementations, the selected domain is a customer-specific domain.

In some implementations, the documentation includes at least a portion of one or more of: a technical sheet for the industrial automation device, a programming manual for the industrial automation device, a troubleshooting guide for the industrial automation device, and a user training manual for the industrial automation device.

In some implementations, the method further includes transmitting to the user device, with the list of prerequisites, instructions to spotlight the list of prerequisites in the GUI.

### BRIEF DESCRIPTION OF THE DRAWINGS

FIG. 1 illustrates an industrial automation environment in an implementation.

FIG. 2 illustrates a user device in an implementation

FIG. 3 illustrates an application service in an implementation.

FIG. 4 illustrates a domain in an implementation.

FIG. 5 illustrates a process for providing guided maintenance workflows in an implementation.

FIG. 6 illustrates an operational sequence in an implementation.

FIGS. 7A-7D illustrate user interfaces in an implementation.

FIG. 8 illustrates a computing system suitable for implementing the various operational environments, architectures, environments, processes, scenarios, sequences, and frameworks discussed below with respect to the other Figures.

### DETAILED DESCRIPTION

When performing maintenance (e.g., regular maintenance, troubleshooting, issue resolution, and the like) for an automation device in an industrial automation environment, technicians typically try to ensure they have met all prerequisites for performing the maintenance. For example, to perform troubleshooting for a capacitor failure in a drive, prerequisites may include having the necessary tools (e.g., an oscilloscope, tools for accessing the interior, specialized tools for replacing the capacitors), replacement components (e.g., spare capacitors in case replacement is called for), and safety equipment (e.g., hard hat, gloves, safety glasses). Furthermore, while performing the troubleshooting, technicians should be aware of certain safety precautions. For example, following certain steps in the correct order could be important to avoid damaging the automation device, causing safety issues (e.g., electrical or mechanical) that may endanger the technician or others around the automation device, and the like.

In existing environments, relevant information for performing maintenance is often dispersed across multiple locations, such as different documents or various sections of the same document. For instance, a troubleshooting guide may outline the steps to be taken but omit the prerequisites for the sake of brevity, assuming that the technician is already familiar with them. In some cases, the prerequisites might be detailed elsewhere, such as in training materials or user manuals. However, novice technicians may not be aware of these prerequisites, and even experienced technicians might prefer to have a clear list of prerequisites readily available. The inefficiencies created by having to track down this scattered information can result in significant delays, as technicians must spend valuable time searching for the necessary details instead of immediately performing the maintenance. Additionally, when prerequisites and safety precautions are not immediately accessible, there is an increased risk of technicians performing procedures incorrectly, which can lead to further errors, extended downtime, damage to equipment, and bodily harm, particularly if safety precautions are not followed.

The present disclosure describes an industrial automation environment featuring an application service that offers guidance to users for performing maintenance. Maintenance may include regular maintenance, troubleshooting issues, and any other mechanical tasks performed on industrial automation devices in industrial automation environments. While examples of troubleshooting are often used to describe the technology, any maintenance task may benefit from using the disclosed technology. In the industrial automation environment, the application service may leverage a general artificial intelligence (GAI) model to extract and consolidate relevant information including which steps to perform and the order in which to perform them, prerequisites for each step, and safety precautions to follow. The application service may provide this guidance for any given maintenance process including regular maintenance, troubleshooting issues, and the like. The application service may deliver this guidance (i.e., comprehensive workflow information) to a user device for display. For example, technicians can access an integrated interface where they can view the guidance, improving efficiency and safety by reducing the time it takes the technician to obtain the necessary information and ensuring the technician will not find that a tool is not on hand mid-workflow and that a safety step is missed for failure to find important safety precautions before commencing the maintenance.

The application service may receive requests for guided workflows for performing maintenance or troubleshooting in industrial automation devices. For example, a technician may request the guided workflow via the integrated interface. The requests may identify a specific device and provide details about the maintenance needed. For example, the maintenance may be an error on the device (e.g., a capacitor failure), regular maintenance, or the like. The application service may retrieve relevant documentation for performing the maintenance (e.g., documentation for troubleshooting the error) from a device-specific domain. This documentation may include multiple documents, such as device technical sheets, troubleshooting guides, training materials, programming manuals, and the like. The application service may generate a prompt for the GAI model, including an identification of the maintenance, the retrieved documentation, a request for prerequisite information, and a request for a list of steps for performing the troubleshooting. In some implementations, the prompt may also include a request for safety precautions related to the maintenance process.

The GAI model responds to the application service with ordered steps for performing the maintenance, prerequisites, and safety precautions, according to some implementations. Specifically, the GAI model may extract each relevant piece of information from the documentation provided in the prompt. The application service thus obtains consolidated maintenance information to present to the user. The list of maintenance steps may be presented to the technician through a user interface on the user device (e.g., the integrated interface). Additionally, any prerequisites and safety precautions may be displayed alongside the steps (e.g., in banners at the top of the user interface, as a separate listing available in a specific tab, or the like). This ensures that the technician has the prerequisite and safety information readily available while performing the troubleshooting.

In some implementations, the steps are displayed in a checklist format. As the technician completes each step, the technician may select the step to mark it as complete within the user interface. Once all steps are marked complete, the application service may generate a maintenance report for the technician, which may be stored in a maintenance file. In some cases, such report and storage may help ensure compliance with company policies and eliminate inefficiencies by providing contextual metrics such as time on a particular step, time to resolve, and the like.

The application service described herein enhances operational efficiency by minimizing downtime and reducing the likelihood of errors and safety issues during maintenance, as technicians can access all necessary steps, prerequisites, and safety precautions in one interface. Workplace safety is improved by ensuring that precautions are less likely to be overlooked. Furthermore, the application service may improve efficiency in the usage of computing resources. Specifically, the application service optimizes resources by selectively retrieving and processing only relevant documentation from specific domains, reducing unnecessary data handling. Furthermore, the application service reduces the need for redundant document searches and manual extraction of information from scattered sources.

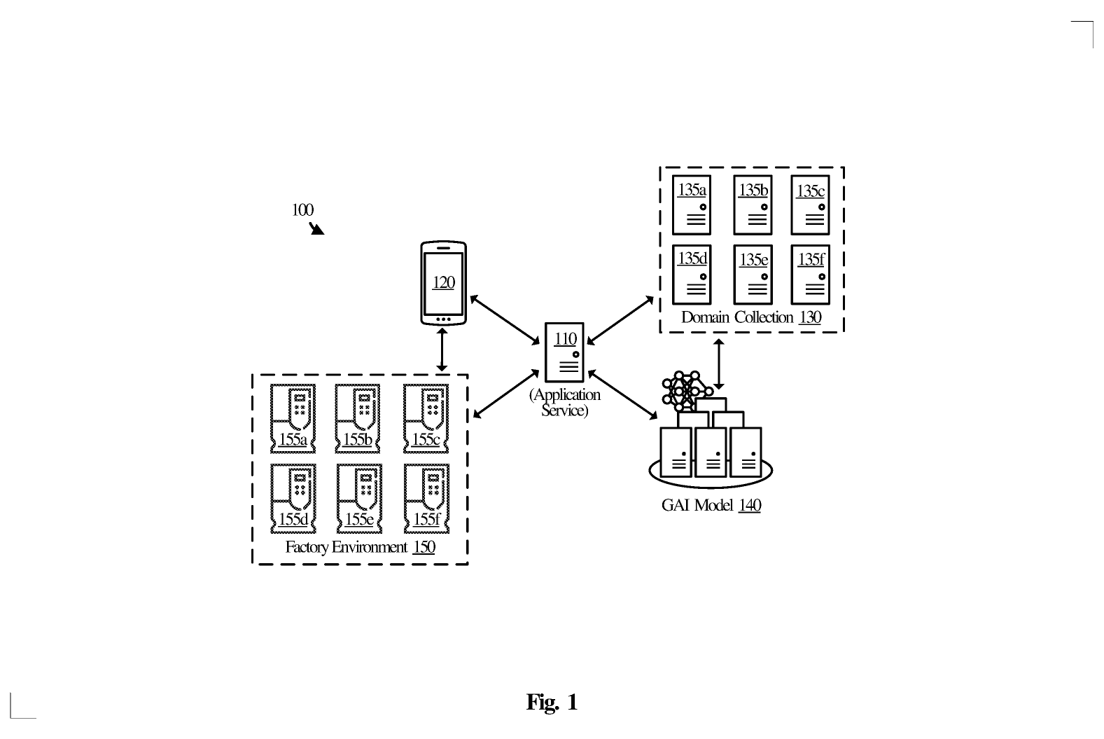

FIG. 1 illustrates industrial automation environment 100 in an implementation. Industrial automation environment 100 includes application service 110, user device 120, domain collection 130, GAI model 140, and factory environment 150. Application service 110 is in communication with user device 120, domain collection 130, GAI model 140, and factory environment 150. User device 120 is in communication with application service 110 and factory environment 150. Domain collection 130 is in communication with GAI model 140.

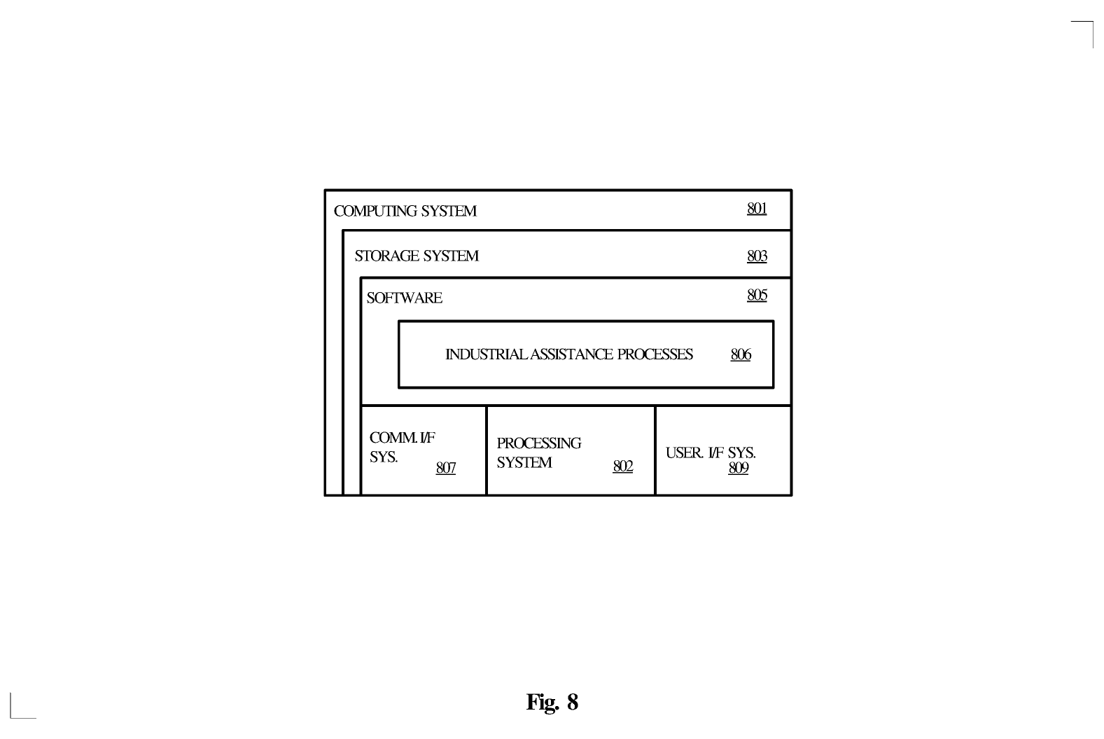

Application service 110 is a service for providing industrial assistance to users. Application service 110 may include software operating on one or more servers, which may be represented by computing system 801 of FIG. 8. In other implementations, application service 110 may be a cloud-based service. Application service 110 may be hosted by an industrial manufacturer in some implementations. Specifically, application service 110 may be provided to assist customers (e.g., a user on user device 120) in the execution of various tasks.

Application service 110 is configured to leverage GAI model 140 to enable users (e.g., on user device 120) to interact with a “chatbot” with which a user may submit queries and receive responses. Application service 110 receives these queries and prompts GAI model 140 to generate the responses, as described in greater detail herein. These queries may include requests for guided workflows for maintenance tasks, as well as natural language queries (e.g., “How do I install my PowerFlex 755T?”).

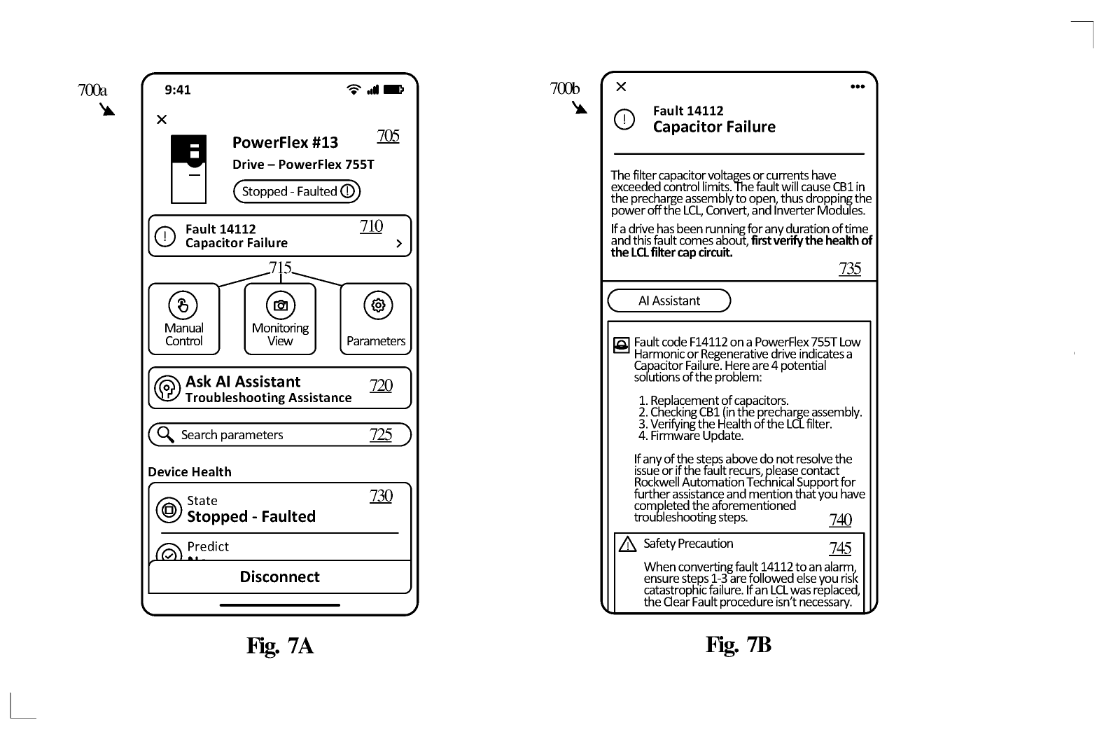

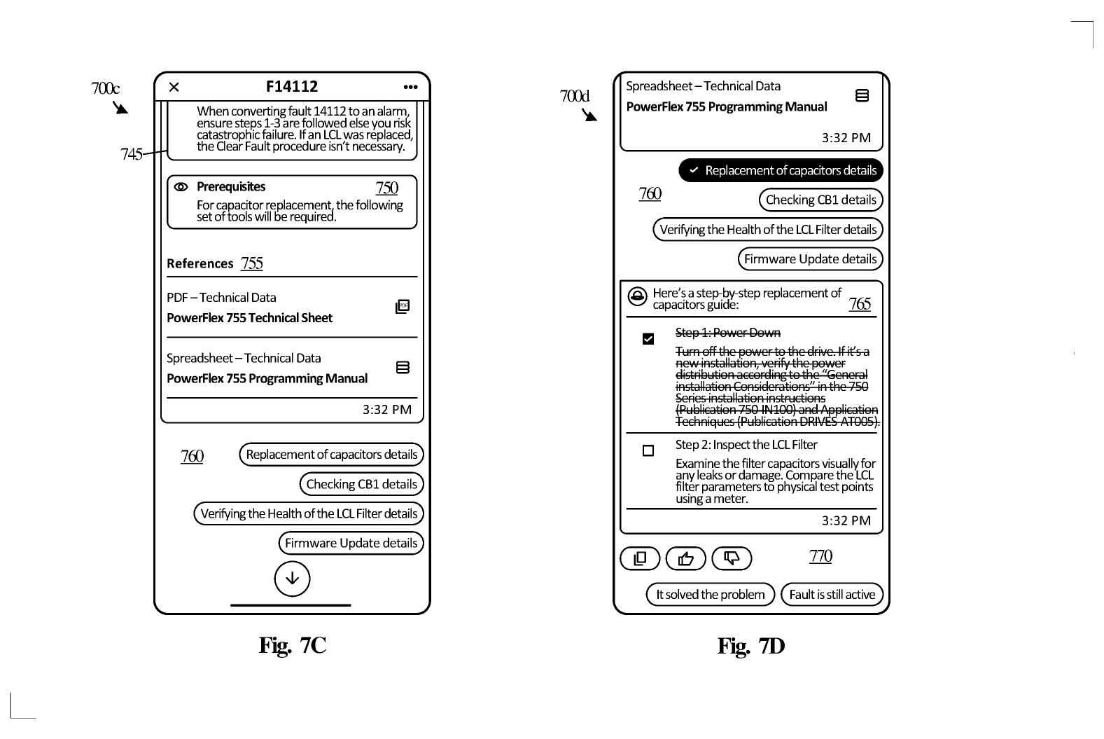

In some implementations, application service 110 selects one or more domains 135 from domain collection 130 based on the submitted queries. Application service 110 may select the domains 135a-135f using various methods. For example, where the query is a request for a guided workflow, application service 110 may select a device-specific domain 135 based on a device-type identified in the request. In another scenario, application service 110 may make the selection based on a QR code scan by user device 120, as discussed in greater detail in relation to domain selection module 310 below. In other scenarios, application service 110 may select a domain 135 by prompting GAI model 140 to select one or more domains 135 based on the user-submitted query.

Where the query is a request for a guided workflow for maintenance tasks, application service 110 may retrieve device-specific documentation from a device-specific domain 135 to generate assistance prompts for GAI model 140. The assistance prompts task GAI model 140 with generating a list of steps for performing the maintenance, a list of prerequisites for performing the maintenance, and a list of safety precautions for performing the maintenance. Upon receiving a response from GAI model 140, application service 110 transmits the guided workflow information to user device 120 for display (as illustrated, for example, in user interfaces 700a-700d of FIGS. 7A-7D).

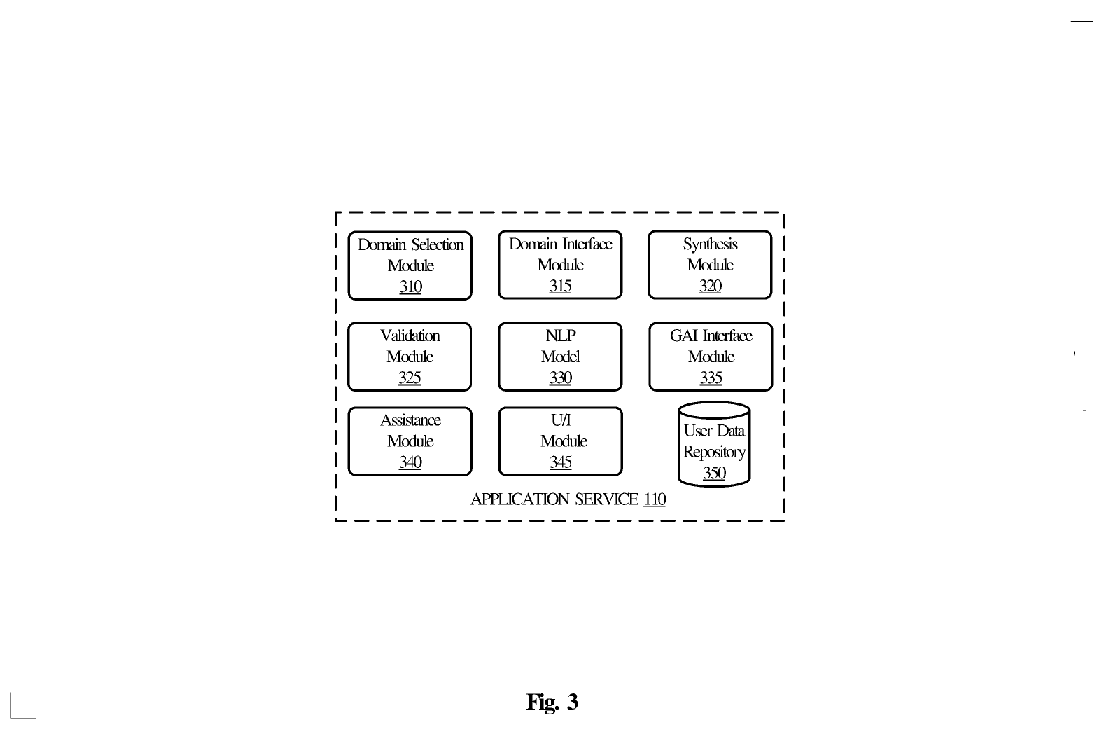

Application service 110 is also configured to manage user data in a user data repository, such as user data repository 350 of FIG. 3. The user data may include a list of devices (e.g., industrial automation devices 155a-155f) that the user has interacted with. Application service 110 may also store historical conversations between the user and the chatbot. Application service may also store identifications of which conversations and responses have been pinned by the user on user device 120, as discussed in greater detail with respect to FIG. 3 below.

User device 120 is a device utilized by users in industrial automation environment 100 to obtain industrial assistance. User device 120 may be a cell phone, tablet, laptop, human interface module (HIM), personal computer, or any other device capable of interfacing with application service 110. User device 120 may be represented by computing system 801 in FIG. 8. While one user device 120 is shown in FIG. 1 for simplicity, industrial automation environment 100 may include many user devices 120, with multiple users interacting with application service 110.

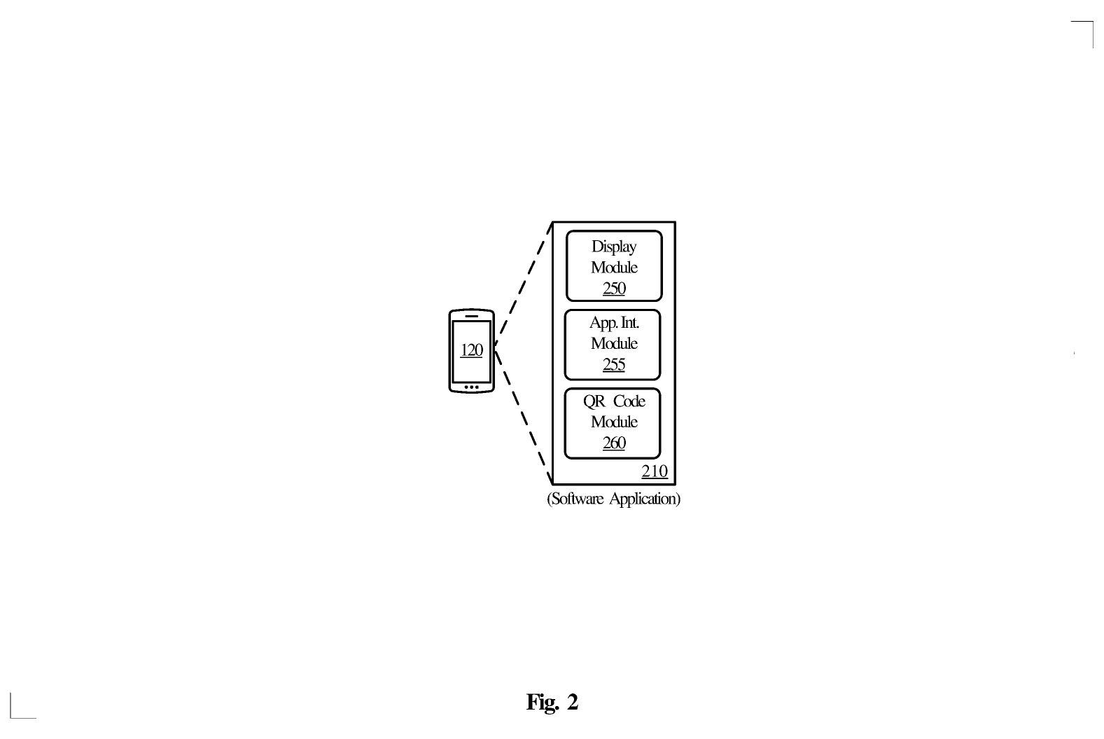

User device 120 may run device applications that interact with application service 110. For example, device applications running on user device 120 may include a software application (i.e., software application 210 described below in the discussion of FIG. 2), in which a user may interact with a chatbot by submitting queries such as natural language requests and requests for guided workflows. In some implementations, application service 110 may be a web-based application allowing user access via a web-browser. In either case, the user may submit queries and view responses from application service 110 on a user interface of user device 120.

Domain collection 130 is representative of a collection of domains 135a, 135b, 135c, 135d, 135e, 135f (collectively, “domains 135”) in industrial automation environment 100. While six domains 135 are shown in FIG. 1 for simplicity, it is noted that domain collection 130 may include any number of domains 135. Each domain 135 may include software operating on one or more servers, which may be represented by computing system 701 of FIG. 7.

Domains 135 are services configured to provide assistance with respect to specific aspects of the industrial automation environment 100. For example, each model of device (e.g., PowerFlex 755T) may have an associated domain 135 directed to that model. Some domains 135 may be customer-specific domains storing customer specific information (e.g., design preferences and customer-specific safety precautions). Various tasks (e.g., industrial control logic generation) may also have an associated domain 135. Accordingly, domain collection 130 as a whole is capable of providing aid in a wide range of needs that arise in industrial automation environment 100.

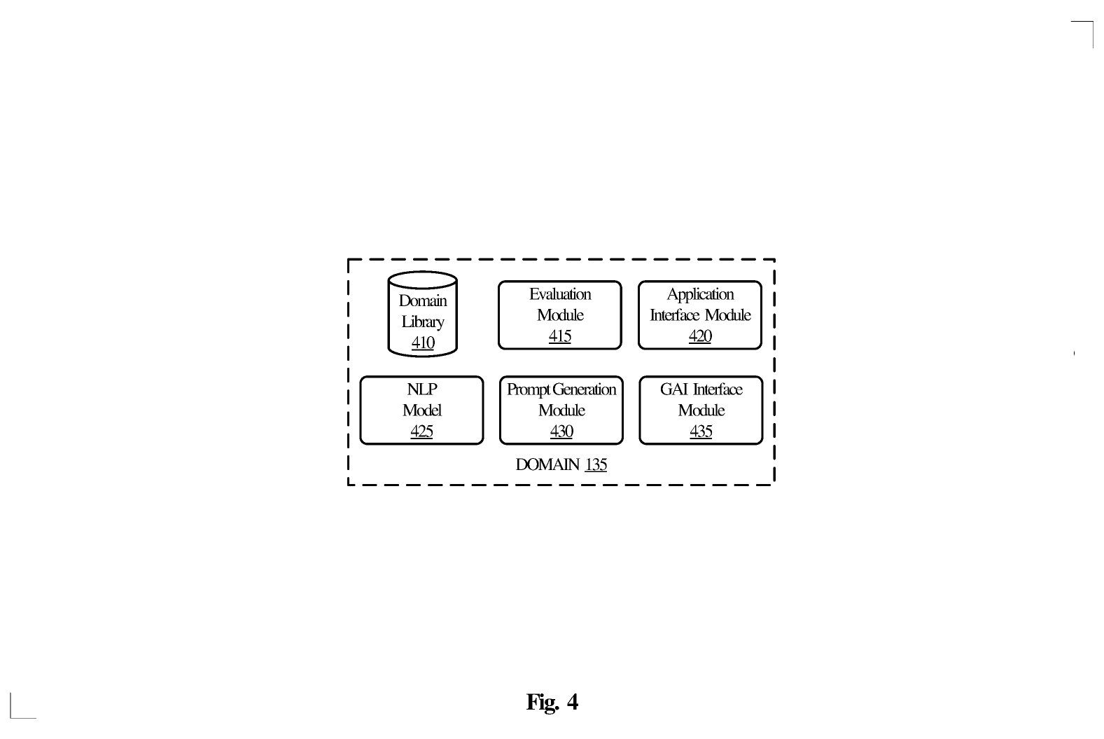

Domains 135 are configured to receive calls from application service 110. For device-specific domains, these calls may include requests for device-specific documentation (which application service 110 may use to generate assistance prompts requesting a guided workflow). To this end, device-specific domains 135 maintain a library (e.g., domain library 410 of FIG. 4) storing documentation associated with the device, including, for example, technical sheets, user manuals, and troubleshooting guides. In some implementations, domains 135 retrieve this documentation and provide it to application service 110 for prompt generation. In other implementations, domains 135 may themselves generate an assistance prompt requesting a guided workflow, as discussed in greater detail in the discussion of process 500 below.

Factory environment 150 is representative of an environment executing industrial processes (e.g., manufacturing, packaging, warehousing, etc.). Factory environment 150 includes a wide range of components for performing the industrial processes, including industrial automation industrial automation devices 155a, 155b, 155c, 155d, 155e, 155f (collectively “industrial automation industrial automation devices 155”) illustrated in FIG. 1. While six industrial automation industrial automation devices 155 are shown in FIG. 1 for simplicity, industrial automation environment 100 may include any number of industrial automation industrial automation devices 155.

Industrial automation devices 155 are representative of various devices that may operate in factory environment 150, including, for example, variable frequency drives (VFDs), direct on line controllers, starters, PLCs, robotic devices and the like. Operators (users) in factory environment 150 perform many tasks associated with industrial automation devices 155, including selecting the units, designing the system, configuring industrial automation industrial automation devices 155, and maintaining industrial automation devices 155. The users may, in some cases, perform various tasks by interacting with industrial automation devices 155 directly via user device 120. For example, users may configure and troubleshoot industrial automation devices 155 via user device 120 connected to the industrial automation devices 155 (e.g., via a Bluetooth connection, USB connection, near field communication (NFC), etc.).

Industrial automation devices 155 may have affixed QR codes. These QR codes may be affixed to industrial automation devices. For example, the QR code may be on a sticker on the casing or packaging of industrial automation device 155, or may be visible in a screen of industrial automation device 155 (such as in a human interface module). These QR codes may encode information above the device such as catalog numbers, serial numbers, and device types. These QR codes may be scanned by user device 120 to obtain device-specific assistance, as explained further below.

GAI model 140 is an artificial intelligence model designed to process and generate natural language text. GAI model 140 may consist of a system of transformer-based neural networks with a vast number of parameters (weights and balances). It is trained on massive amounts of textual data, enabling it to generate relevant responses based on given prompts or input text. In some implementations, GAI model 140 may be fine-tuned using industrial data, such as product specifications and manuals. Alternatively, GAI model 140 may be a generically trained model that utilizes its general training, along with the context of the prompts, to provide assistance specifically tailored to the industrial automation environment 100. Depending on the implementation, GAI model 140 may be hosted and operated by a third party or by an industrial manufacturer, and it may run from cloud infrastructure or one or more data centers.

GAI model 140 is configured to receive prompts from application service 110 and domains 135. Prompts from application service 110 may include troubleshooting prompts requesting assistance for device-specific troubleshooting, domain selection prompts requesting GAI model 140 to identify appropriate domains 135 for responding to a user-submitted query, synthesization prompts requesting GAI model 140 to synthesize responses received from domains 135, and validation prompts requesting GAI model 140 to validate a synthesized response. These various prompts are described in greater detail in co-pending case “SYNTHESIZING DOMAIN-BASED RESPONSES IN INDUSTRIAL AUTOMATION SYSTEMS LEVERAGING GENERATIVE ARTIFICIAL INTELLIGENCE,” attorney docket no. 2024P-227-US, incorporated by reference above.

Generative artificial intelligence (GAI) models (also sometimes known as foundation models) are models trained to generate new data based on a training dataset. GAI models as used herein include large-scale generative artificial intelligence (AI) models trained on massive quantities of diverse, unlabeled data. The GAI models learn using self-supervised, semi-supervised, or unsupervised techniques. GAI models perform many downstream tasks based on capturing general knowledge, semantic representations, and patterns and regularities in the training data. In some embodiments, such as embodiments included herein, a GAI model may be fine-tuned for specific downstream tasks. GAI models include BERT (Bidirectional Encoder Representations from Transformers) and ResNet (Residual Neural Network). GAI models may be based on any relevant architecture, including, for example, generative adversarial networks (GANs), variational auto-encoders (VAEs), and transformer models, including multimodal transformer models. Depending on the type of input accepted and output provided, GAI models may be multimodal or unimodal.

Multimodal models are a class of GAI model that accepts multimodal data including text, image, video, and audio data. Multimodal models may leverage techniques like attention mechanisms and shared encoders to fuse information from different modalities and create joint representations. Learning joint representations across different modalities enables multimodal models to generate multimodal outputs that are coherent, diverse, expressive, and contextually rich. For example, multimodal models can generate a caption or textual description of a given image by extracting visual features using an image encoder, then feeding the visual features to a language decoder to generate a descriptive caption. Similarly, multimodal models can generate an image based on a text description (or, in some scenarios, a spoken description transcribed by a speech-to-text engine). Multimodal models work in a similar fashion with video—generating a text description of the video or generating video based on a text description.

Multimodal models include visual-language foundation models, such as CLIP (Contrastive Language-Image Pre-training), ALIGN (A Large-scale ImaGe and Noisy-text embedding), and ViLBERT (Visual-and-Language BERT), for computer vision tasks. Examples of visual multimodal or foundation models include DALL-E, DALL-E 2, Flamingo, Florence, and NOOR. Types of multimodal models may be broadly classified as or include cross-modal models, multimodal fusion models, and audio-visual models, depending on the particular characteristics or usage of the model.

Large language models (LLMs) are a type of GAI model that process and generate natural language text. These models are trained on massive amounts of textual data. LLMs learn to generate relevant responses given a prompt or input text. The responses are coherent and contextually relevant to the given prompt. LLMs understand and generate sophisticated language based on their training. LLMs capture intricate patterns, semantics, and contextual dependencies in textual data. In some cases, LLMs may be used in multimodel models. For example, the LLM intelligence is used to combine images and audio input with textual input to generate multimodal output. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, BERT (Bidirectional Encoder Representations from Transformer) models, ERNIE (Enhanced Representation through kNowledge IntEgration) models, T5 (Text-to-Text Transfer Transformer), and XLNet models are types of transformer models which have been pretrained on large amounts of text data using a self-supervised learning technique called masked language modeling. For example, large language models, such as ChatGPT and its brethren, have been pretrained on an immense amount of data across virtually every domain of the arts and sciences. This pretraining allows the models to learn a rich representation of language that can be fine-tuned for specific NLP tasks, such as text generation, language translation, or sentiment analysis. Moreover, these models have demonstrated emergent capabilities in generating responses that are creative, open-ended, and unpredictable.

It is noted that FIG. 1 illustrates an implementation that includes one GAI model 140. However, it is noted that in some implementations, industrial automation environment 100 may include multiple GAI models. For instance, one GAI model could handle requests from application service 110, while another GAI model (or several others) manages requests from domains 135.

FIG. 2 illustrates user device 120 in an implementation. User device 120 executes software application 210, which is representative of an industrial chatbot application that assists a user in various tasks such as device troubleshooting. Software application 210 may be stored in memory of user device 120 (represented for example by storage system 803 of FIG. 8) and executed by one or more processors (represented for example by processing system 802 of FIG. 8) of user device 120. Software application 210 provides a user interface in the display of user device 120, to provide users with device information and receive configuration selections. Software application 210 includes display module 250, application interface module 255, and QR code module 260, which are representative of elements of software application 210 performing the functions explained below.

Display module 250 is representative of a module configured to receive user inputs and provide information for display in a user interface. The display module 250 is designed to generate and present a user interface through which a user may interact with the system, including submitting queries to a chatbot (e.g., requests for guided workflows for troubleshooting and maintenance) and receiving responses. Example user interfaces provided by display module 250 are illustrated in FIGS. 7A-7D.

Application interface module 255 is configured to handle communication between user device 120 and application service 110. This module is responsible for transmitting user queries, requests, and any other data from user device 120 to the application service 110, as well as receiving responses, guided workflows, and other relevant information. Application interface module 255 ensures the smooth exchange of data, allowing the system to process user requests and return the necessary information to be displayed via display module 250.

QR code module 260 is configured to resolve scanned QR codes. This module enables the user device 120 to scan QR codes (using a camera on user device 120) located on industrial automation devices. The QR codes on these industrial automation devices 155 contain specific information such as device type, catalog numbers and serial numbers. Upon scanning, QR code module 260 decodes the information and sends it to application service 110, which may use the data for prompt generation, as discussed further below.

FIG. 3 illustrates a detailed view of application service 110. Application service 110 includes domain selection module 310, domain interface module 315, synthesis module 320, validation module 325, natural language processing (NLP) model 330, GAI interface module 335, assistance module 340, user interface (U/I) module 345, and user data repository 350. While these modules and elements are depicted to describe the generation of synthesized domain-based responses, the functionalities described may be incorporated into more or fewer components, software components, hardware components, firmware components, or a combination without departing from the scope and spirit of the present disclosure.

User interface (U/I) module 345 is a module configured to interface with user device 120. U/I module 345 receives user-submitted queries (e.g., request for guided workflows for performing maintenance) from user device 120 and provides responses to user device 120. U/I module 345 may also perform various other user interface functions, including receiving feedback from users and managing user authentication and continuity.

Domain selection module 310 is configured to select appropriate domains 135 for responding to user-submitted queries. Where a user query is a request for a guided workflow for performing maintenance, domain selection module 310 may select a device-specific domain 135 based on a type of device (e.g., “PowerFlex 755T) specified in the user request. In some implementations, domain selection module 310 may select domains based on device information obtained from user device 120 by scanning a QR code on industrial automation device 155. Domain selection module 310 may also use other techniques for selecting domains, such as leveraging GAI model 140.

Domain interface module 315 is configured to interface with domains 135. In some implementations, domain interface module 315 interfaces with domains 135 (selected by domain selection module 310) to obtain documentation for assistance prompts requesting guided workflows from GAI model 140. Specifically, domain interface module 315 submits requests for the documentation to domains 135 and receives the documentation from domains 135. This documentation may include device-specific documentation obtained from device-specific domains 135, and customer-specific documentation retrieved from customer-specific domains 135. This documentation provides contextual information in assistance prompts generated by assistance module 340 discussed below.

Assistance module 340 is configured to generate an assistance prompt for GAI model 140. These assistance prompts may be generated in response to user queries requesting assistance installing industrial automation devices 155, configuring industrial automation devices 155, and performing maintenance on industrial automation devices 155, among other tasks. In some implementations, these assistance prompts may request a guided maintenance and troubleshooting workflow. This assistance prompt may task GAI model 140 with generating a list of prerequisites associated with performing the maintenance, a list of steps for performing the maintenance, and a list of safety precautions for the list of maintenance. The assistance prompt further includes the documentation obtained from domains 135 by domain interface module 315 (as discussed above). Once assistance module 340 generates the assistance prompt, GAI interface module 335 submits the assistance prompt to GAI model 140, as described further below. Assistance module 340 also tracks steps marked complete by users (as seen in element 765 of user interface 700d of FIG. 7D), and auto-generates a maintenance report upon completion of all the steps.

GAI interface module 335 is a module configured to interface with GAI model 140. GAI interface module 335 performs preprocessing on prompts generated by other modules (e.g., assistance prompts generated by assistance module 340). After preprocessing, GAI interface module 335 submits the refined prompts to GAI model 140 for processing. Once GAI model 140 generates responses, GAI interface module 335 receives these responses and conducts an initial validation, which includes checking for syntax errors and ensuring the responses meet basic correctness criteria before passing them along for further operations.

User data repository 350 is representative of a data repository storing information about users of application service 110. User data repository 350 stores store details such as the user's name, position, organization, location, language preference, and historical conversations, including previously submitted queries and the responses generated for those queries. User data repository 350 may also maintain a list of devices for each user, including industrial automation device 155 that the user has interacted with. Additionally, the repository can store information across various users, capturing historical conversations, pinned chats, and pinned responses. This stored information allows the system to personalize user experiences further, tailor synthesized responses and incorporate conversational elements into responses. Furthermore, user data repository 350 tracks the steps marked complete (e.g., in element 765 of user interface 700d in FIG. 7D) in the list of steps during maintenance workflows.

Synthesis module 320 is configured to synthesize responses received from GAI model 140. The responses received from GAI model 140, as described herein, may be synthesized by synthesis module 320 before providing them to user device 120. For example, where GAI model 140 is prompted separately for general and user-specific prerequisites/safety precautions, synthesis module 320 may synthesize the different responses into a single response.

Validation module 325 is configured to validate the responses received from GAI model 140. Validation module 325 may orchestrate both general evaluation procedures and domain specific evaluation according to some embodiments.

Natural Language Processing (NLP) model 330 is a specialized model designed to process user-submitted natural language queries by analyzing the natural language within them. NLP model 330 may be utilized for domain selection according to some implementations (e.g., by identifying a device type in a natural-language query). Synthesis module 320, validation module 325, and NLP model 330 and various other elements are described in greater detail in co-pending case “SYNTHESIZING DOMAIN-BASED RESPONSES IN INDUSTRIAL AUTOMATION SYSTEMS LEVERAGING GENERATIVE ARTIFICIAL INTELLIGENCE,” attorney docket no. 2024P-227-US, incorporated by reference above.

FIG. 4 is a detailed view of domain 135, which is representative of each of domains 135a, 135b, 135c, 135d, 135e, 135f illustrated in FIG. 1. Domain 135 includes domain library 410, evaluation module 415, application interface module 420, NLP model 425, prompt generation module 430, and GAI interface module 435. While these modules and elements are depicted to describe the operation of domain 135, the functionalities described may be incorporated into more or fewer components, software components, hardware components, firmware components, or a combination without departing from the scope and spirit of the present disclosure.

Domain library 410 is representative of a repository storing documentation associated with each domain. For example, where domain 135 is a domain for an industrial automation device, domain library 410 may include technical sheets, programming manuals, troubleshooting guides, installation guides, and user training manuals for industrial automation device 155, among other types of documentation. Where domain 135 is a customer-specific domain, domain library 410 may include customer-specific safety documentation, and customer specific maintenance procedures, among other types of documentation. Documentation may be retrieved by application interface module 420 and provided to application service 110 in response to requests (e.g., where application service requests the documentation for generation of assistance prompts for guided workflow). In other implementations, prompt generation module 430 of domain 135 may itself utilize documentation from domain library 410 to generate assistance prompts, as discussed further below.

Application interface module 420 is a module configured to interface with application service 110. Application interface module 420 receives requests from application service 110 (e.g., requests for device-specific documentation or customer-specific safety documentation) and provides generated domain-specific responses (e.g., documentation retrieved from domain library 410 described above) to application service 110.

Prompt generation module 430 is a module configured to generate domain prompts to GAI model 140. It is noted that, while application service 110 may generate assistance prompts in some implementations (as described in FIG. 3 above), in other implementations domain 135 may itself generate and submit the assistance prompts. These assistance prompts may be substantially the same as the assistance prompt described above with respect to assistance module 340.

GAI interface module 435 is a module configured to interface with GAI model 140. GAI interface module 435 performs preprocessing on prompts generated by prompt generation module 430. After preprocessing, GAI interface module 435 submits the refined prompts to GAI model 140 for processing. Once GAI model 140 generates responses, GAI interface module 435 receives these responses and conducts an initial validation, which includes checking for syntax errors and ensuring the responses meet basic correctness criteria before passing them along for further operations. In implementations in which domains 135 generate assistance prompts, GAI interface module 435 submits the assistance prompts to GAI model 140 and receives the generated response. Application interface module 420 then provides the GAI-generated responses to application service 110.

Evaluation module 415 is a module configured to provide domain-specific evaluation procedures to application service 110. Evaluation module 415 may maintain descriptions of appropriate domain procedures that may be used by application service 110 to perform the domain-specific evaluation discussed above.

NLP model 425 is a model designed to process the domain-specific calls by analyzing the natural language within them. NLP model 425 may enable domain 135 to generate domain-specific responses to various types of requests from application service 110. NLP model 425, evaluation module 415, and various other elements are described in greater detail in co-pending application “SYNTHESIZING DOMAIN-BASED RESPONSES IN INDUSTRIAL AUTOMATION SYSTEMS LEVERAGING GENERATIVE ARTIFICIAL INTELLIGENCE,” attorney docket no. 2024P-227-US, incorporated by reference above.

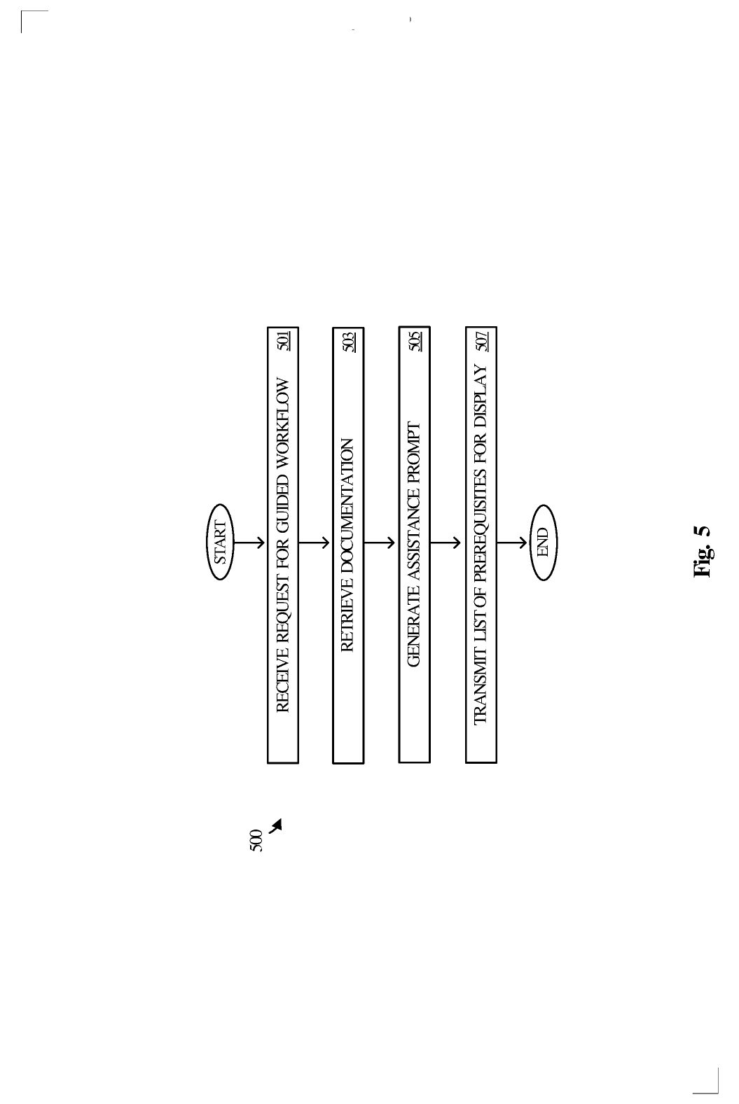

FIG. 5 illustrates a guided troubleshooting process, represented by process 500. Process 500 is employed by one or more computing devices, an example of which is provided by computing system 801 of FIG. 8. Process 500 may be implemented in program instructions (software and/or firmware) by one or more processors of the computing device. The program instructions direct the computing device to operate as follows, referring to the steps in FIG. 5.

Step 501 of process 500 is receiving, from user device 120, a request for a guided workflow for performing maintenance on industrial automation device 155. Step 501 is performed by application service 110, and more specifically, by U/I module 345 of FIG. 3. A user may submit the request via a user interface on user device 120 (e.g., by selecting element 720 of user interface 700a of FIG. 7A). The request may identify the device type and an identification of an error on industrial automation device 155 (e.g., user interface 700a of FIG. 7A illustrates a scenario where a “Heatsink Over Temperature” fault has occurred on a PowerFlex 755T).

Step 503 of process 500 is retrieving documentation associated with industrial automation device 155. In step 503, domain selection module 310 may select one or more domains 135 based on the device type identified in the request (as discussed in greater detail with respect to FIG. 3 above). The selected domain 135 could include one or both of a device-specific domain 135 and a customer-specific domain 135. The device-specific domain 135 is selected based on the particular type of device (e.g., “PowerFlex 755T”) identified in the request of step 501. The customer-specific domain 135 is selected based on the organization of the user submitting the request.

Once the domains 135 are selected, domain interface module 315 submits a request to the selected domains 135 for documentation relevant to performing the maintenance (e.g., troubleshooting the “Heatsink Over Temperature” error). In response, domain 135 retrieves relevant documentation from domain library 410. The relevant documentation from a device-specific domain 135 may include at least a portion of one or more of: a technical sheet for the industrial automation device, a programming manual for the industrial automation device, a troubleshooting guide for the industrial automation device, and a user training manual for the industrial automation device. Documentation retrieved from a customer-specific domain 135 may include customer-specific safety documentation and maintenance procedures. The selected domains 135 provide this documentation to application service 110 for prompt generation in some implementations. In other implementations, a selected domain 135 may itself generate a prompt including the documentation, as discussed further below.

Step 505 of process 500 is generating an assistance prompt for GAI model 140. In some implementations, step 505 is performed by assistance module 340 of application service 110. Specifically, when application service 110 receives the documentation from domain 135, assistance module 340 generates an assistance prompt for GAI model 140. The assistance prompt tasks GAI model 140 with generating a list of prerequisites associated with performing the maintenance and an ordered list of steps for performing the maintenance, as well as safety precautions for performing the maintenance according to some implementations. The assistance prompt includes the documentation retrieved from the selected domains 135 (see step 503 above), and an identification of the maintenance (e.g., troubleshooting an issue on industrial automation device 155 such as an “Overspeed” error). Once the assistance prompt has been generated, GAI interface module 335 submits the prompt to GAI model 140.

In other implementations, step 505 is performed by prompt generation module 430 of the selected domains 135. After retrieving the documentation from domain library 410, prompt generation module 430 generates the assistance prompt described above, and GAI interface module 435 submits the assistance prompt to GAI model 140. Accordingly, either application service 110 or domains 135 may submit the prompt to GAI model 140 in various implementations.

Upon receiving the assistance prompt (from either application service 110 or domain 135) GAI model 140 generates a response that includes the maintenance information including the list of prerequisites, the list of safety precautions, and the list of steps. GAI model 140 uses the documentation as contextual information for generating the response (noting that relevant maintenance information may be scattered across various sections of the documentation, such as troubleshooting steps in a troubleshooting guide and prerequisites in a user manual). The list of safety precautions includes customer-specific precautions extracted from the customer-specific safety documentation and general precautions extracted from the device-specific documentation. The response is then returned to application service 110 through the application’s GAI interface module 335 or to domain 135 via the domain’s GAI Interface module 435.

In some implementations, application service 110 (or domain 135) may generate and submit multiple prompts to obtain the troubleshooting information from GAI model 140. For example, a first prompt may request the list of steps, a second prompt may request the list of prerequisites, and the third prompt may request the list of safety precautions.

Step 507 is transmitting the list of prerequisites to user device 120 for display. Step 507 is performed by application service 110, and more specifically by U/I module 345 of FIG. 3. Element 750 of FIG. 7C, for example, illustrates element 750 which a user may select to view a list of prerequisites. Step 507 may also include transmitting the list of steps and the list of safety precautions to user device 120 for display (see, e.g., element 745 of FIG. 7B and element 765 of FIG. 7D, respectively).

Application service 110 (in particular, U/I module 345) transmits, to user device 120, instructions to spotlight the list of prerequisites and the list of safety precautions in the user interface (such as user interfaces 700a-700d of FIGS. 7A-7D). This spotlighting may involve various techniques to ensure that the prerequisites are prominently displayed and easily noticed by the user. For example, the lists of prerequisites and safety precautions enclosed within a banner to draw attention to the lists (as illustrated in user interfaces 700b-700d). Spotlighting could also include displaying the lists in bold or highlighted. Spotlighting may also include using flashing borders, color changes, or animated highlights around the prerequisites list to ensure visibility and user engagement, among other techniques to draw attention to the lists.

Application service 110 (in particular, U/I module 345) also transmits instructions to user device 120 to display the list of steps in a checklist format. This enables the user to view and interact with each step through a user interface. For instance, element 765 of user interface 700d of FIG. 7D shows the steps presented in a checklist format, allowing the user to track progress of the maintenance process.

The user may mark the completion of individual steps in the list of steps, as illustrated in element 765 (“Step 1”) of user interface 700d. Application service 110 (in particular, U/I module 345) receives the user’s selection of a step, signifying that the step has been completed, and transmits instructions to mark the selected step as complete within the user interface. This interaction provides visual feedback, updating the checklist in real-time to reflect which steps have been completed.

Once all the steps in the checklist are marked as complete, application service 110 (in particular, assistance module 340) may generate a maintenance report. Organizations may have standardized procedures for submitting maintenance reports to ensure consistency and compliance with regulatory or internal guidelines. Application service 110 can be configured to store these standardized forms or templates, which are then used to automatically generate the reports based on the completed steps. By utilizing pre-stored templates, the application service 110 ensures that all required information is captured accurately and consistently, streamlining the documentation process for maintenance tasks. This autogeneration of reports can help organizations maintain accurate records while reducing the time and effort required to manually create detailed reports.

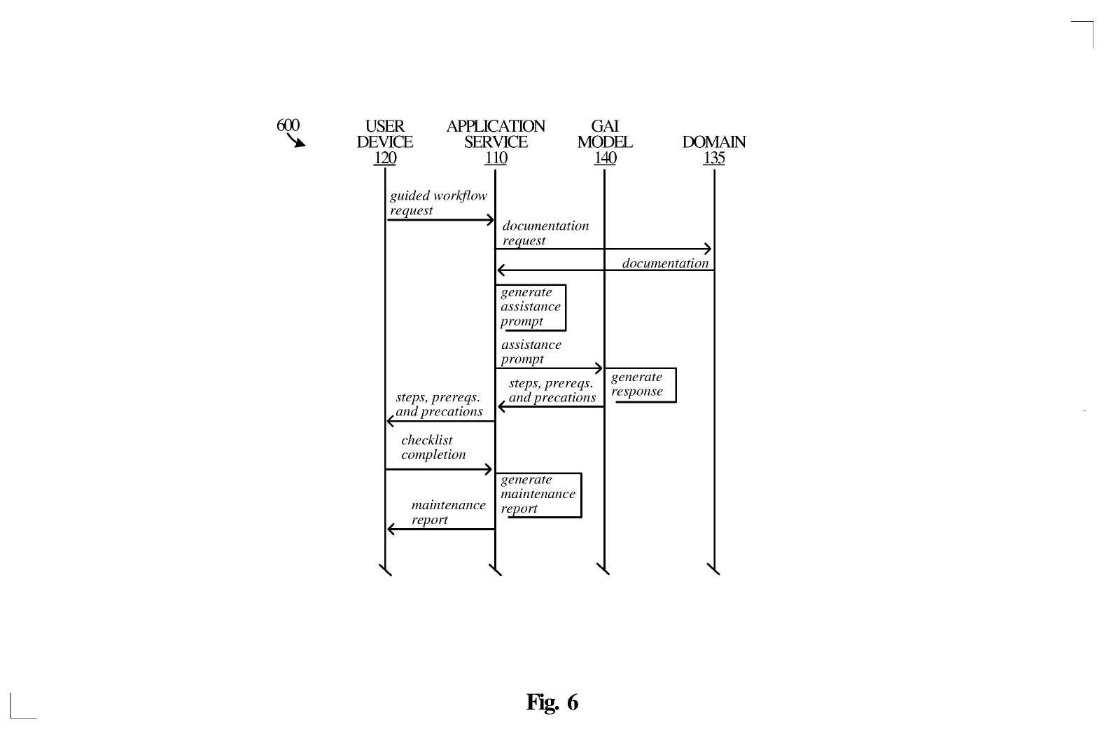

FIG. 6 illustrates an operational sequence of an application of process 500 in the context of industrial automation environment 100 in an implementation, represented by sequence 600. Sequence 600 includes user device 120, application service 110, GAI model 140, and domain 135.

In operational sequence 600, a user on user device 120 submits, to application service 110, a request for a guided workflow for performing maintenance on industrial automation device 155 (see discussion of step 501 of process 500 above). The user may submit the request by selecting an element in a user interface of user device 120, such as element 720 of user interface 700a, illustrated in FIG. 7A. The request includes a device type (e.g., PowerFlex 755T) and an identification of maintenance to be performed (e.g., and identification of an error such as Heatsink Over Temperature). Application service 110 submits a documentation request to domain 135, requesting documentation relevant for performing the maintenance. Domain 135 provides the documentation to application service 110 (see discussion of step 501 of process 500 above). Application service 110 generates an assistance prompt and submits the assistance prompt to GAI model 140 (see discussion of step 505 of process 500 above). GAI model 140 generates a response to the assistance prompt, including a list of steps, a list of prerequisites, and a list of precautions for performing the maintenance, and provides the response to application service 110. Application service 110 transmits the list of steps, list of prerequisites, and the list of precautions to user device 120 for display (see step 507 of process 500 above). Upon receiving these lists, a user performing maintenance marks steps in the list of steps in complete in the user interface (as illustrated by way of example in element 765 of user interface 700d). Once the user completes the checklist (e.g., marks each step in the list of steps as complete), application service 110 automatically generates a maintenance report, which it then provides to user device 120.

FIGS. 7A-7D illustrate user interfaces 700a, 700b, 700c, 700d of user device 120 (of FIG. 1) according to some implementations. User interfaces 700a, 700b, 700c, 700d illustrate a sequence of interfaces displayed in a screen of user device 120 for a user performing maintenance on industrial automation device 155. It is noted that user interfaces 700a, 700b, 700c, 700d illustrate some examples; in other implementations user interfaces on user device 120 may have different arrangements, different elements, or additional or fewer elements. In some implementations, user interfaces 700a-700d may be displayed on a touchscreen of user device 120, allowing users to select elements by tapping. In other implementations, these interfaces may appear on other display types, where users can select elements using mouse or keyboard inputs.

FIG. 7A illustrates user interface 700a in an implementation. User interface 700a represents a display showing high-level information about industrial automation device 155. User interface 700a may be displayed, for example, when a user connects or obtains information from industrial automation device 155 (e.g., via a Bluetooth connection, NFC connection, USB connection, etc.). Element 705 displays high-level information about industrial automation device 155, including a device identification (“PowerFlex #13”) a device type (“PowerFlex 755T”) and a health state (in this example, “Stopped-Faulted” indicates that industrial automation device has stopped to a Fault condition). Element 710 illustrates a banner identifying the fault condition (“Fault 14112 Capacitor Failure”). A user may select element 710 to view high-level information about the fault condition, such as a brief description of the fault, which may be stored in a data repository of application service 110. Elements 715 are selectable options that allow the user to perform various actions related to industrial automation device 155. These actions include “Manual Control” (which the user may select to manually operate the device, such as specifying operational parameters or overriding automatic control to adjust output values), “Monitoring View” (which the user may select to observe real-time operational data of the device, including input/output values, status, and performance metric), and “Parameters” (which the user may select to access and modify device parameters such as fault thresholds, operating limits, or other configurable settings).

Element 720 represents an element a user may select to request assistance from GAI model 140. A user selection of element 720 represents a request for a guided workflow for performing the maintenance (in this case for addressing the fault condition), as discussed above with respect to step 501 of process 500. Element 725 represents an input field in which a user may search for various parameters in industrial automation device 155 (e.g., speed, voltage, temperature, etc.). Element 730 illustrates an expanded view of the device health status (in this indicating that industrial automation device 155 has stopped due to a fault condition).

FIG. 7B illustrates user interface 700b in an implementation. User interface 700b (along with user interfaces 700c, 700d) illustrates a display of a guided workflow transmitted by application service 110 (as discussed above with respect to step 507 of process 500). Element 735 includes a brief description of the fault condition. Element 740 includes an introduction to the guided workflow provided by application service 110 with GAI model assistance. Element 745 illustrates a banner illustrating a list of safety precautions for performing the maintenance. This list of safety precautions may be generated by GAI model 140, as discussed above with respect to step 505 of process 500.

FIG. 7C user interface 700c in an implementation. User interface 700c is a continuation of user interface 700b (e.g., in which a user has scrolled down from the user interface 700b). Element 745 illustrates the list of safety precautions as discussed with respect to user interface 700b above. Element 750 illustrates a list of prerequisites – in this case, there is one prerequisite indicating that a set of tools is required to perform the maintenance. A user may select element 750 to view the set of tools. This list of prerequisites may be generated by GAI model 140, as discussed above with respect to step 505 of process 500. Element 760 includes an overview of different maintenance procedures (“Replacement of capacitors,” “Checking CB1,” etc.) to be performed. In this example, these maintenance procedures include steps to address the “Capacitor Failure” fault condition.

FIG. 7D illustrates user interface 700d in an implementation. User interface 700d is a continuation of user interface 700c (e.g., in which a user has scrolled down from the user interface 700c). Element 760 includes an overview of different maintenance procedures as discussed above in relation to FIG. 7C. In user interface 700d, the user has selected “Replacement of capacitors details” in order to view the list of steps for replacing the capacitors. Element 765 illustrates the list of steps for performing the maintenance. This list of steps may be generated by GAI model 140, as discussed above with respect to step 505 of process 500. The steps illustrated in element 765 are selectable by the user to mark them complete after performance of the step. In the example in user interface 700d, the user has selected “Step 1: Power Down” to indicate that the step of powering down industrial automation device 155 has been completed. Accordingly, the guided workflow provided to the user allows the user to keep track of the progress made in the troubleshooting progress.

Element 770 includes selectable feedback options, including “It solved the problem” indicating that the procedure corrected the issue (in this case a capacitor failure), “Fault is still active” indicating that the procedure did not correct the problem, a thumb’s up symbol indicating that the response was helpful, and a thumbs down symbol indicating that the response was not helpful. Selection of these options may be used as feedback for tuning GAI model 140, as well as initiation of further assistance (e.g., where a user indicates that the fault is still active).

FIG. 8 illustrates a computing system 801 that is representative of any system or collection of systems in which the various processes, programs, services, and scenarios disclosed herein may be implemented. Examples of the computing system 801 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

The computing system 801 may be implemented as a single apparatus, system, or device or may be implemented in a distributed manner as multiple apparatuses, systems, or devices. The computing system 801 includes, but is not limited to, a processing system 802, a storage system 803, software 805, a communication interface system 807, and a user interface system 809. The processing system 802 is operatively coupled with the storage system 803, the communication interface system 807, and the user interface system 809.

The processing system 802 loads and executes software 805 from the storage system 803. The software 805 includes and implements the industrial assistance processes 806, which is (are) representative of the application service processes discussed with respect to the preceding figures, such as the process 500 of FIG. 5. When executed by the processing system 802, the software 805 directs the processing system 802 to operate as described herein for at least the various processes, operational scenarios, and sequences discussed in the foregoing implementations. The computing system 801 may optionally include additional devices, features, or functionality not discussed for purposes of brevity.

Referring still to FIG. 8, the processing system 802 may comprise a microprocessor and other circuitry that retrieves and executes the software 805 from the storage system 803. The processing system 802 may be implemented within a single processing device but may also be distributed across multiple processing devices or sub-systems that cooperate in executing program instructions. Examples of the processing system 802 include general purpose central processing units, graphical processing units, application specific processors, and logic devices, as well as any other type of processing device, combinations, or variations thereof.

The storage system 803 may comprise any computer-readable storage media device readable by the processing system 802 and capable of storing the software 805. The storage system 803 may include volatile and nonvolatile, removable, and non-removable media implemented in any method or technology for storage of information, such as computer readable software instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated or transitory signal.

In addition to computer-readable storage media, in some implementations the storage system 803 may also include computer readable communication media over which at least some of the software 805 may be communicated internally or externally. The storage system 803 may be implemented as a single storage device but may also be implemented across multiple storage devices or sub-systems co-located or distributed relative to each other. The storage system 803 may comprise additional elements, such as a controller, capable of communicating with the processing system 802 or possibly other systems.

The software 805 (including industrial assistance processes 806) may be implemented in program instructions and among other functions may, when executed by the processing system 802, direct the processing system 802 to operate as described with respect to the various operational scenarios, sequences, and processes illustrated herein. For example, software 805 may include program instructions for implementing an industrial assistance process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. The software 805 may also comprise firmware or some other form of machine-readable processing instructions executable by the processing system 802.

In general, the software 805 may, when loaded into the processing system 802 and executed, transform a suitable apparatus, system, or device (of which the computing system 801 is representative) overall from a general-purpose computing system into a special-purpose computing system customized to support an application service in an optimized manner. Indeed, encoding software 805 on the storage system 803 may transform the physical structure of the storage system 803. The specific transformation of the physical structure may depend on various factors in different implementations of this description. Examples of such factors may include, but are not limited to, the technology used to implement the storage media of the storage system 803 and whether the computer-storage media are characterized as primary or secondary storage, as well as other factors.

Unless the context clearly requires otherwise, throughout the description and the claims, the words "comprise," "comprising," and the like are to be construed in an inclusive sense, as opposed to an exclusive or exhaustive sense; that is to say, in the sense of "including, but not limited to." As used herein, the terms "connected," "coupled," or any variant thereof means any connection or coupling, either direct or indirect, between two or more elements; the coupling or connection between the elements can be physical, logical, or a combination thereof. Additionally, the words "herein," "above," "below," and words of similar import, when used in this application, refer to this application as a whole and not to any particular portions of this application. Where the context permits, words in the above Detailed Description using the singular or plural number may also include the plural or singular number respectively. The word "or," in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” “in an implementation,” “in some implementations,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words "means for", but use of the term "for" in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. (Currently Amended) A computer-implemented method for guiding maintenance and troubleshooting on an industrial automation device, comprising:
receiving, by an application service, a request for a guided workflow for performing maintenance on an industrial automation device, wherein the request identifies a device type of the industrial automation device;
selecting, based on the identified device type, a domain from a plurality of domains each associated with a respective device type, wherein each of the plurality of domains comprises:
an interface module configured to interface with the application service, and
a repository storing documentation associated with the respective device type;
submitting, by the application service and to the interface module of the selected domain, a retrieval request for documentation associated with the device type;
receiving, at the application service and from the interface module of the selected domain, the documentation retrieved from the repository of the selected domain;
generating an assistance prompt designed to elicit a response from a general artificial intelligence (GAI) model, wherein the assistance prompt tasks the GAI model with generating a list of prerequisites associated with performing the maintenance and an ordered list of steps for performing the maintenance, and wherein the assistance prompt includes the documentation and an identification of the maintenance; and
transmitting, by the application service, the list of prerequisites to a user device for display via a graphical user interface (GUI).

2. The computer-implemented method of claim 1, wherein:the assistance prompt further tasks the GAI model with generating a list of safety precautions to follow while performing the maintenance; andthe method further comprises transmitting, by the application service, the list of safety precautions to the user device for display via the GUI.

3. The computer-implemented method of claim 2, wherein:the assistance prompt further comprises customer-specific safety documentation; andthe list of safety precautions includes customer-specific precautions extracted from the customer-specific safety documentation and general precautions extracted from the documentation.

4. The computer-implemented method of claim 1, further comprising:transmitting, by the application service, instructions to the user device to display the ordered list of steps in checklist format.

5. The computer-implemented method of claim 4, further comprising:receiving, via the GUI, a user selection of a step from the ordered list of steps to indicate completion of the step; andtransmitting instructions to mark the step as complete in the GUI.

6. The computer-implemented method of claim 5, further comprising,generating, by the application service a maintenance report in response to each step in the ordered list of steps being marked complete; andproviding, by the application service, the maintenance report to the user device.

7. The computer-implemented method of claim 1 , wherein the list of prerequisites identifies one or more of:tools for performing the maintenance,replacement components for performing the maintenance, or safety equipment for performing the maintenance .

8. The computer-implemented method of claim 1 , further comprising:selecting a customer-specific domain from a second plurality of domains each associated with a respective customer, wherein the selection of the customer-specific domain is based on an organization of a user submitting the request for the guided workflow; andretrieving customer-specific documentation from the customer-specific domain,wherein the assistance prompt further includes the customer-specific documentation.

9. The computer-implemented method of claim 1, wherein the documentation comprises at least a portion of one or more of: a technical sheet for the industrial automation device, a programming manual for the industrial automation device, a troubleshooting guide for the industrial automation device, and a user training manual for the industrial automation device.

10. The computer-implemented method of claim 1, further comprising:transmitting to the user device, with the list of prerequisites, instructions to spotlight the list of prerequisites in the GUI.

11. A system to facilitate guided device maintenance and troubleshooting, the system comprising:
one or more processors; and
one or more memories operably coupled to the one or more processors and having stored thereon software instructions that, upon execution by the one or more processors,cause the one or more processors to:receive, by an application service, a request for a guided workflow for performing maintenance on an industrial automation device, wherein the request identifies a device type of the industrial automation device;select, based on the identified device type, a domain from a plurality of domains each associated with a respective device type, wherein each of the plurality of domains comprises:an interface module configured to interface with the application service, anda repository storing documentation associated with the respective device type;
submit, by the application service and to the interface module of the selected domain, a retrieval request for documentation associated with the identified device type;
receive, at the application service and from the interface module of the selected domain, the documentation retrieved from the repository of the selected domain;
generate an assistance prompt designed to elicit a response from a general artificial intelligence (GAI) model, wherein the assistance prompt tasks the GAI model with generating a list of prerequisites associated with performing the maintenance and an ordered list of steps for performing the maintenance, and wherein the assistance prompt includes the documentation and an identification of the maintenance; and
transmit, by the application service, the list of prerequisites to a user device for display via a graphical user interface (GUI).

12. The system of claim 11, wherein:the assistance prompt further tasks the GAI model with generating a list of safety precautions to follow while performing the maintenance; andthe software instructions comprise further instructions that, upon execution by the one or more processors, cause the one or more processors to:transmit the list of safety precautions to the user device for display via the GUI.

13. The system of claim 12, wherein:the troubleshooting prompt further comprises customer-specific safety documentation;and the list of safety precautions includes customer-specific precautions extracted from the customer-specific safety documentation and general precautions extracted from the documentation.

14. The system of claim 11, wherein the software instructions comprise further instructions that, upon execution by the one or more processors, cause the one or more processors to:transmit, by the application service, instructions to the user device to display the ordered list of steps in checklist format.

15. The system of claim 14, wherein the software instructions comprise further instructions that, upon execution by the one or more processors, cause the one or more processors to:receive, via the GUI, a user selection of a step from the ordered list of steps to indicate completion of the step; andtransmit instructions to mark the step as complete in the GUI.

16. The system of claim 15, wherein the software instructions comprise further instructions that, upon execution by the one or more processors, cause the one or more processors to:
generate, by the application service, a maintenance report in response to each step in the ordered list of steps being marked complete; and
provide, by the application service, the maintenance report to the user device.

17. The system of claim 11, wherein the list of prerequisites identifies one or more of:tools for performing the maintenance,replacement components for performing the maintenance, or safety equipment for performing the maintenance select a domain associated with the industrial automation device in response to the rcqucst for the guidcd workflow, whcrcin the documentation is rctricvcd from the sclcctcd domain.

18. The system of claim 11, wherein the software instructions comprise further instructions that, upon execution by the one or more processors, cause the one or more processors to:select acustomer-specific domain from a second plurality of domains each associated with a respective customer, wherein the selection of the customer-specific domain is based on an organization of a user submitting the request for the guided workflow; andretrieve customer-specific documentation from the customer-specific domain,wherein the assistance prompt further includes the customer-specific documentation.

19. The system of claim 11, wherein the documentation comprises at least a portion of one or more of: a technical sheet for the industrial automation device, a programming manual for the industrial automation device, a troubleshooting guide for the industrial automation device, and a user training manual for the industrial automation device.

20. The system of claim 11, wherein the software instructions comprise further instructions that, upon execution by the one or more processors, cause the one or more processors to:transmit to the user device, with the list of prerequisites, instructions to spotlight the list of prerequisites in the GUI.
